(19) United States
(12) Patent Application Publication
(10) Pub. No.: US 2008/0153002 A1
(43) Pub. Date: Jun. 26, 2008

(54) Mixed Lithium/Sodium Ion Iron Fluorophosphate Cathodes for Lithium Ion Batteries

(76) Inventors: Linda Faye NAZAR, Waterloo (CA); Michael Makahnouk, Waterloo (CA); Brian Ellis, Port Hope (CA); Kathryn Toghill, Caernarfon (GB); Yoshinari Makimura, Kashihara (JP)

Correspondence Address: STEPHEN R. BURRI, MILLER THOMSON LLP, 1000 - 840 HOWE STREET, VANCOUVER, BC, V6Z 2M1, omitted

(21) Appl. No.: 11/946,038

(22) Filed: Nov. 27, 2007

Related U.S. Application Data
(60) Provisional application No. 60/861,058, filed on Nov. 27, 2006.

(51) Int. Cl. H01M 4/52; C01B 25/10

(52) U.S. Cl. 429/221; 423/301; 252/182.1

(57) ABSTRACT

A compound having the formula LiₐNa₂₋ₐFePO₄F, wherein 0<a≦2 may be synthesized by exchanging lithium ions for sodium ions in Na₂FePO₄F. The compound may be used as a cathode material for a lithium ion battery. A battery may be comprised of an electrode active material having the formula Li₂FePO₄F, an anode; and an electrolyte. Na₂FePO₄F may be synthesized by flux reaction. Microcrystalline Na₂FePO₄F may be synthesized by a solution method. Na₂FePO₄F may be used as a cathode material for a lithium ion battery and may be carbon composite coated.

This application claims priority from U.S. Provisional Patent application No. 60/861,058 filed Nov. 27, 2006.

### TECHNICAL FIELD

The present invention relates to batteries. In particular, the present invention relates to improved lithium and sodium ion battery cathode materials.

### BACKGROUND OF THE INVENTION

Lithium (“Li”) ion batteries may provide longer lasting, safe, more environmentally sound batteries than other existing battery technologies. Lithium technology provides 75% of worldwide sales in rechargeable batteries. Li is the most electropositive element (−3.04V vs. SHE), allowing for the greatest amount of chemical energy to be harnessed. Lithium has a low molecular weight (6.939 gmol⁻¹) and low density (0.53 gcm⁻³). Monovalent cations such as lithium have faster ionic mobility than multivalent cations owing to their smaller electrostatic attraction to the host material framework. As lithium ions are the conducting monovalent cations with the smallest radius (76 pm), apart from hydrogen ions, they can be reversibly intercalated from a cathode material.

Lithium metal oxide cathodes such as LiCoO₂ have been commercialized, but this class of oxides is considered impractical for cathode materials as the theoretical capacity is unattainable for safety reasons. Deep discharge can lead to oxidation of the cathode and the electrolyte, high cell impedance and overheating. Therefore, LiCoO₂, for example, is not a practical cathode material for advanced or large-scale lithium ion batteries, restricting this technology to portable electronic devices.

Other layered metal oxides have been considered but did not turn out to be viable alternatives to LiCoO₂. Some, such as the nickel oxide of LiNiO₂, are not as thermally stable as its cobalt counterpart. LiFeO₂ has electrochemical problems because it operates on 3⁺/4⁺ redox couple and, in the case of iron, this transition is not favourable in the solid-state. The electronic configuration for Fe³⁺ is high spin d⁵ and is very stable because all electrons are unpaired. But oxidizing this metal would require the removal of one electron, which would produce a Jahn-Teller d⁴ state, which is not desirable in the solid-state. This transition would require a high voltage making it useless in lithium ion battery technology due to electrolyte degradation.

Extensive effort has been undertaken to improve the capacity by electronic substitution of other transition metals such as Ni and Mn into the layered structure to make the properties of these elements more cobalt-like. Although LiNi_{0.5}Mno_{0.5}O₂ can attain capacities of roughly 200 mAh/g, it has issues of cation ordering. Roughly 7% of the Ni is located in the lithium layers, creating kinetic hindrance to ion transport because Ni in the lithium layers impedes lithium migration. LiNi_{0.33}Mn_{0.33}Co_{0.33}O₂ has a capacity that can reach 220 mAh/g, but exhibits capacity fade over cycling. Although these are dramatic improvements when compared to LiCoO₂, their drawbacks led to the search for new materials having open framework structures.

Two phosphate materials, olivine LiFePO₄ and Li₃V₂(PO₄)₃ have been shown to have a better practical capacity than LiCoO₂. LiFePO₄, has a theoretical capacity of 170 mAh/g, while Li₃V₂(PO4)₃, has a related sodium superionic conductor structure, nearly reaching its theoretical capacity of 200 mAh/g in working cells.

Lithium iron phosphate (triphylite) is one of the most promising candidates for cathode materials. It has the olivine structure (M₂XO₄, where X=Be²⁺, B³⁺, Si⁴⁺, or P⁵⁺). The low toxicity, and low cost of synthesis of LiFePO₄ make this material an attractive alternative to the layered oxides for hybrid electric vehicles. Most importantly, it has been demonstrated to address most of the safety issues associated with the layered metal oxides.

Lithium iron phosphate can be prepared by a variety of methods including solid state, sol-gel, and hydrothermal synthetic methods. Triphylite (LiFePO₄) can attain a capacity of 150-165 mAh/g, but it has low inherent conductivity. Several surface modification techniques have been employed to improve the inherent electronic conductivity in the material, including carbon coating, addition of silver or copper, and phosphidation. The addition of carbon aids electronic transport by improving the capacity of the active material. However, an excess of carbon will produce materials with low tap density and poor lithium mobility at the crystallite surfaces.

Due to low inherent conductivity of the olivine phosphates and limitations of one-dimensional ion transport, the development of new open-framework structures which allow good alkali ion mobility is an active area of lithium ion battery research. Phosphates, silicates, sulphates and fluorophosphates are being studied as intercalation hosts.

Materials for use as positive electrodes in lithium ion batteries should ideally possess a redox centre. The host structure should react reversibly with lithium ions. It should have a high capacity of at least one mole Li per mole transition metal, and a voltage between 3 and 4.5 V. The material should exhibit facile pathways for insertion and removal of lithium ions. This favors high power density which is important, for example, for batteries that can be recharged using hybrid electric vehicle regenerative braking. The material should be stable over many cycles of lithium insertion and deinsertion. It should be comprised of low cost, non hazardous elements and be environmentally benign to allow for easy disposal and low waste toxicity. The material should lack active hydroxyl groups that would undergo irreversible redox reaction, and should lack structural water that could diffuse into the electrolyte. Some lithium metal fluorophosphates have been identified that meet many of the criteria, including Li₅V(PO₄)₂F₂ and LiVPO₄F. LiV^{III}PO₄F has been reported to have a reversible specific capacity of 140 mAh/g, close to its theoretical capacity of 155 mAh/g, and to have a low level of polarization. However, as well as issues of low electronic conductivity, a major impediment to commercialization of this material is vanadium which poses toxic hazards in terms of synthesis and disposal. LiFe^{III}PO₄F as tavorite would not be electrochemically active as a lithium-ion cathode due to the high voltage of the Fe^{3+/4+} couple.

U.S. Pat. No. 6,872,492 (“US'492”) to Barker et al describes use of sodium based materials, including NaVPO₄F, Na₂FePO₄F and (Li,Na)₂FePO₄F, as cathode materials in a battery. However, this patent is directed to sodium ion battery technology, not lithium ion batteries. US'492 describes methods of solid state synthesis of electrode material compounds. Two of these, Na₂FePO₄F and (Li,Na)₂FePO₄F, were not known materials at the time. No enablement of the synthesis or electrochemistry, and no physical characteristics including X-ray diffraction pattern is described in US'492 that would identify Na₂FePO₄F or (Li,Na)₂FePO₄F. In fact, Na₂FePO₄F (and hence the associated (Li,Na)₂FePO₄F material) cannot be prepared according to those teachings, since the synthesis temperature is above that of the now-known decomposition temperature of Na₂FePO₄F.

It would be desirable to provide a novel alkali metal fluorophosphate for use in an electrode for a lithium ion battery, and to provide processes for its synthesis.

### SUMMARY OF THE INVENTION

According to one aspect of the present invention, there is provided a compound having the general formula (LiₐNa₂₋ₐ)FePO₄F, wherein 0<a≦2, preferably 1.4≦2. In one embodiment, the compound may have a conductive coating, preferably a carbon composite or other conductive material.

In another of its aspects, the invention comprises a process for synthesizing (LiNa)FePO₄F from Na₂FePO₄F by exchanging lithium ions for sodium ions in Na₂FePO₄F, the process comprising the following steps: i) refluxing a first time a suspension of Na₂FePO₄F in a solution of LiBr in an organic solvent under an inert atmosphere for a first refluxing period and ii) refluxing an optional second time a suspension of Na₂FePO₄F in a solution of LiBr in an organic solvent under an inert atmosphere for a second refluxing period.

The organic solvent may be acetonitrile, preferably anhydrous acetonitrile. The concentration of LiBr may be between 0.5 and 1.5 M. The inert atmosphere may be argon. The first and second refluxing periods may each be at least 6 hours.

According to one embodiment, the process may include addition to the reflux solution of one molar equivalent of ascorbic acid.

In another of its aspects, the invention comprises a process for synthesizing (Li,Na)FePO₄F by exchanging lithium ions for sodium ions in Na₂FePO₄F, the process comprising the following steps: i) removing one mole of Na from Na₂FePO₄F by chemical or electrochemical oxidation; ii) treating NaFePO₄F with in a solution of LiI in an organic solvent under an inert atmosphere. The chemical oxidant should be capable of extracting Na from the material, and may be NOBF₄, NO₂BF₄, K₂S₂O₈. Preferably the chemical oxidant is NOBF₄.

In another of its aspects, the invention comprises use of (LiₐNa₂₋ₐ)FePO₄F as a cathode material for a lithium ion battery.

In another of its aspects, the invention comprises a battery having a cathode having an electrode active material having the formula (Liₐ,Na₂₋ₐ)FePO₄F, wherein 0<a<2; an anode comprising lithium metal; and an electrolyte.

In another aspect, the invention comprises a process for solution synthesis of Na₂FePO₄F, the process comprising the following steps: i) preparing a precursor solution by dissolving Fe(CH₃COO)₂, H₃PO₄, NaCH₃COO, and NaF in an organic solvent; ii) removing the solvent; iii) ball-milling the resultant powder from step ii) in an inert solvent, or as the dry material; iv) heating the mixture from step iii) at a first temperature for a selected period in an inert atmosphere; v) ball-milling the mixture from step iv); and vi) heat treating the mixture from step v) at a second temperature in the inert atmosphere for a second period.

The first temperature may be at least 300° C. and the first period may be between 30 minutes and 90 minutes. The second temperature may be at least 550° C. but not more than 650° C., and the second period may be between 90 and 150 minutes. The inert atmosphere may be nitrogen gas. In one embodiment, the process may further comprise the additional step of adding 1,3,5-benzene tricarboxylic acid in step i.

In another aspect, the invention comprises a process for solution synthesis of Na₂FePO₄F in aqueous solution, the process comprising the following steps: i) preparing a precursor solution by mixing (NH₄)₂Fe(SO₄)₂, H₃PO₄, NaOH, and NaF in water; ii) heating the mixture in an autoclave under autogeneous pressure at a temperature between 180 and 220° C. for 12-24 hours. Preferably the temperature is 200° C., and the time is 18 hours.

In another aspect, the invention comprises a process for the solid state synthesis of Na₂FePO₄F, the process comprising the following steps: i) ball-milling a stoichiometric amount of N₄H₂PO₄, Fe(C₂O₄).2H₂O, NaHCO₃; ii) heating the mixture under an inert atmosphere to 350° C.; iii) adding a stoichiometric amount of NaF and ball-milling a second time; iv) heating that mixture in an inert atmosphere for a second time. The second temperature may be at least 550° C. but not more than 650° C. and the second period may be 2 and 8 hours. Preferably the temperature is 550° C. and the time is 6 hours.

According to another of its aspects, a cathode material for a lithium ion battery may comprise Na₂FePO₄F, carbon and a binder where the weight percentage of Na₂FePO₄F is between 50% and 99%.

In one of its aspects, the invention may comprise use of Na₂FePO₄F as a cathode material for a lithium ion battery. In another, it may comprise use of carbon composite coated Na₂FePO₄F as a cathode material for a lithium ion battery.

### BRIEF DESCRIPTION OF THE DRAWINGS

A detailed description of the preferred embodiments is provided below by way of example only and with reference to the following drawings, in which:

FIG. 1A shows the diffraction pattern, Rietveld analysis of the single phase microcrystalline Na₂FePO₄F. and crystal structure of Na₂FePO₄F;

FIG. 1B shows the diffraction pattern, Rietveld analysis of the single phase microcrystalline NaFePO₄F, and structure of Na₂FePO₄F derived from the Rietveld analysis;

FIG. 2A illustrates an SEM image of single phase microcrystalline Na₂FePO₄F at magnification 20 k× with inset at magnification 10 k×;

FIG. 2B illustrates the TEM image of a crystallite showing the lattice planes and 3 nm carbon coating on the surface;

FIG. 2C illustrates the EELS linescan of a crystallite, showing the intensity of the elements Fe, P, O, Na and C on the scan and expanded below for Fe, P and C;

FIG. 3 depicts the voltage charge-discharge curve of Na₂FePO₄F;

FIG. 4 shows XRD patterns of Na₂FePO₄F, Na_{1.5}FePO₄F, and NaFePO₄F demonstrating that Na_{1.5}FePO₄F is a discrete material and not a combination of the two phases Na₂FePO₄F and NaFePO₄F;

FIG. 5 shows EDX analysis of the Na/P ratio in the cathode material upon successive charge-discharge cycles in a lithium battery;

FIG. 6 shows a LeBail XRD refinement of Na_{1.5}FePO₄F in P2/c, wRp=9.07%: lattice parameters a=13.929(6), b=5.200(9); c=11.514(7); β=91.22°;

FIG. 7 depicts the voltage charge-discharge curve of Li₂FePO₄F obtained via ion-exchange;

FIG. 8 illustrates the local environment of Na₂FePO₄F showing the face shared Fe octahedral dimers connected to a phosphate tetrahedron;

FIG. 9 illustrates a polyhedral representation of Na₂FePO₄F, showing the Na1 pathway between the three-dimensional network;

FIG. 10 shows diffraction patterns summarizing the purity of the Na₂FePO₄F phases produce via the outlined reaction schemes involving heat treatment overnight Note: (→) indicates Fe₂O₃ (maghemite) and (*) Al sample holder;

FIG. 11 shows diffraction patterns summarizing the purity of the Na₂FePO₄F phases produce via the outlined reaction schemes involving heat treatment for six hours Note: (→) indicates Fe₂O₃ (maghemite) and (*) Al sample holder;

FIG. 12 illustrates morphology and size distribution of aggregates produced by solid-state synthesis methods; magnification of 10 k× (upper) and 20 k× (lower);

FIG. 13 shows diffraction patterns of Na₂FePO₄F produced via solution method;

FIG. 14 illustrates morphology and size distribution of particles produced by EG solution method; magnification of 10 k× (upper) and 20 k× (lower);

FIG. 15 illustrates morphology and size distribution of particles produced by DME solution method, magnification of 10 k× (upper) and 20 k× (lower);

FIG. 16 shows Raman spectrum of Na₂FePO₄F composite produced by solution method;

FIG. 17 shows Raman spectrum of Na₂FePO₄F composite produced by solution method with 1,3,5-benzene tricarboxylic acid;

FIG. 18 shows x-ray diffraction patterns of NaₓFePO₄F illustrating the quasi solid-solution behaviour of the system in the range from x=2→1; and

FIG. 19 shows electrochemical cell test at rate of C/10, showing the reversible capacity of Li₂FePO₄F over several cycles.

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE INVENTION

All terms used herein are used in accordance with their ordinary meanings unless the context or definition clearly indicates otherwise. Also, unless indicated otherwise except within the claims the use of “or” includes “and” and vice-versa. Non-limiting terms are not to be construed as limiting unless expressly stated or the context clearly indicates otherwise (for example, “including”, “having” and “comprising” typically indicate “including without limitation”). Singular forms included in the claims such as “a”, “an” and “the” include the plural reference unless expressly stated or the context clearly indicates otherwise.

A new lithium/sodium iron phosphate. A₂FePO₄F (A=Na, Li) possesses facile two-dimensional pathways for Li ion transport. The structural changes upon reduction-oxidation are minimal. This results in a volume change of only 3.7% that contributes to the absence of distinct two phase behavior during redox and a reversible capacity that is 85% of theoretical.

The discovery of new open-network materials such as phosphates and silicates that have structural features amenable to facile lithium (de)intercalation and beneficial redox potentials is of timely significance, as they present considerable safety advantages over the more commonly used metal oxides. An alternative, lithium metal fluorophosphates have also emerged recently as promising candidates.

Complete substitution of F⁻ is necessary for electrochemical properties since the hydroxy group undergoes irreversible redox reactivity. This can be accomplished synthetically. Moreover, replacement of [PO₄]³⁻ with [PO₄F]⁴⁻ allows for a new family of host lattice structures and compositions, since it alters the charge balance, and the dimensionality of the structure vis-à-vis the corresponding phosphate. Few lithium transition metal fluorophosphates have been described to date, however. A lithium nickel fluorophosphate, Li₂Ni(PO₄)F, along with a cobalt analogue, have inaccessibly high potentials for Li (de) intercalation due to the voltage of the Ni^{2+/3+} or Co^{2+/3+} couple. The V^{3+/4+} process lies at a more ideal potential of ˜4V, as exhibited in LiVPO₄F, and a new layered fluorophosphate, Li₅V(PO₄)₂F₂. The latter exhibits facile 3D pathways for lithium transport, a two electron theoretical capacity (172 mAh/g) equal to LiFePO₄, and good electrochemical properties.

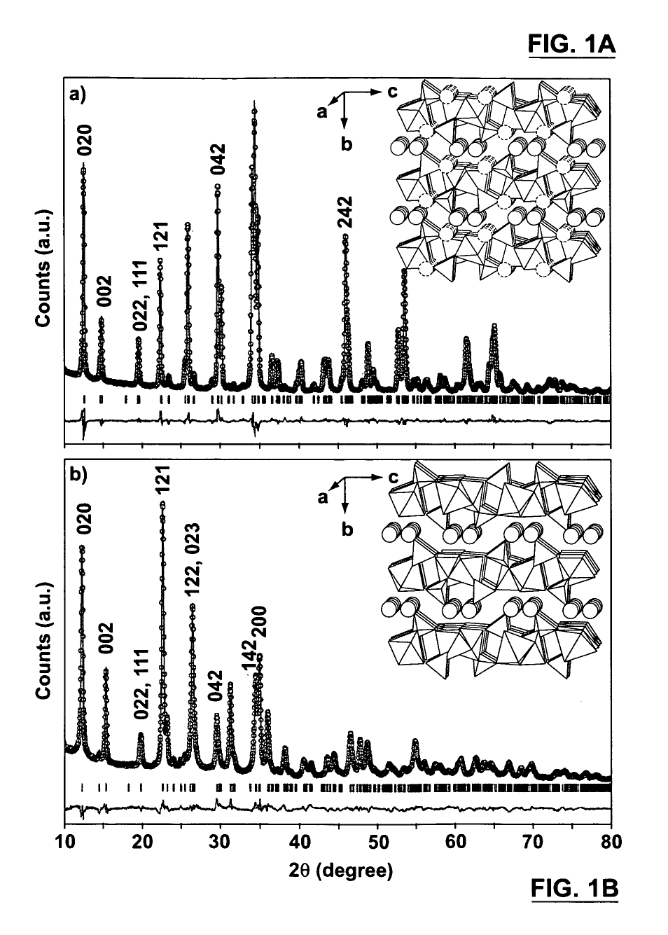

According to the present invention, an environmentally friendly iron-based alkali fluorophosphate is synthesized which operates on the Fe²⁺Fe³⁺ couple, and which, like LiFePO₄, can be prepared in its reduced form to allow it to be used directly as a positive electrode. The material, Na₂FePO₄F, may be prepared as a single crystal shown in FIG. 1A. (lattice parameters in Pbcn are a=5.2200(2)Å, b=13.8540(6)Å, c=11.7792(5)Å) It crystallizes in the Pbcn orthorhombic space group, isostructural with both Na₂FePO₄OH and Na₂Co(PO₄)F. Like the latter, its framework displays unusual features. Bioctahedral Fe₂O₇F₂ units comprised of face sharing FeO₄F₂ octahedra are connected via bridging F atoms to form chains, and joined by PO tetrahedra to form [FePO₄F] infinite layers. The two Na cations located in the interlayer space possess facile two-dimensional migration pathways, and more limited transport in the 3^{rd} dimension. The structure is quite different from that of the analogous Na₂MnPO₄F and Li₂NiPO₄F, compositions which adopt tunnel rather than layered frameworks, and is also different from other layered fluorophosphates Na₅M(PO₄)₂F₂, (M=Fe, Cr, Al) or Na₃M₂(PO₄)₂F₃ (M=Cr, Al, V, Fe).

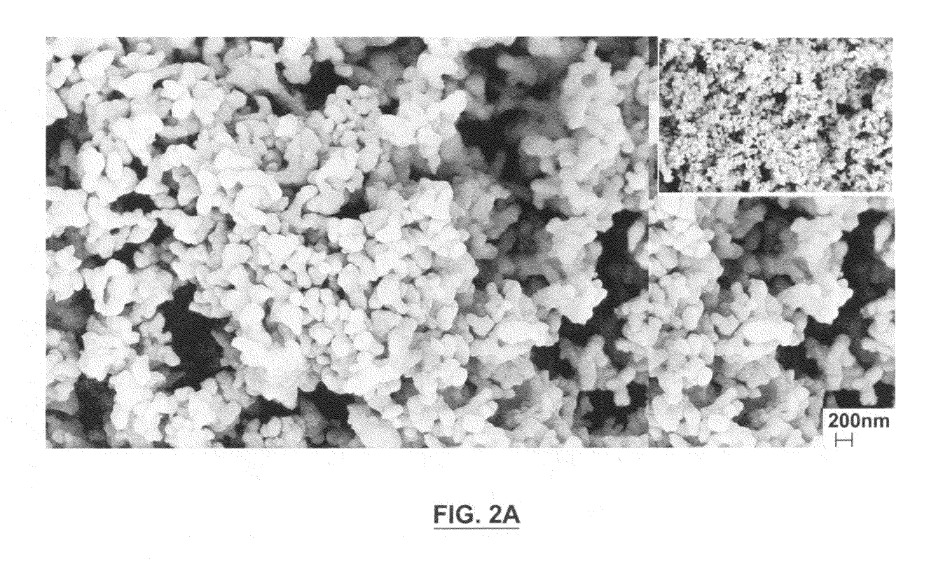

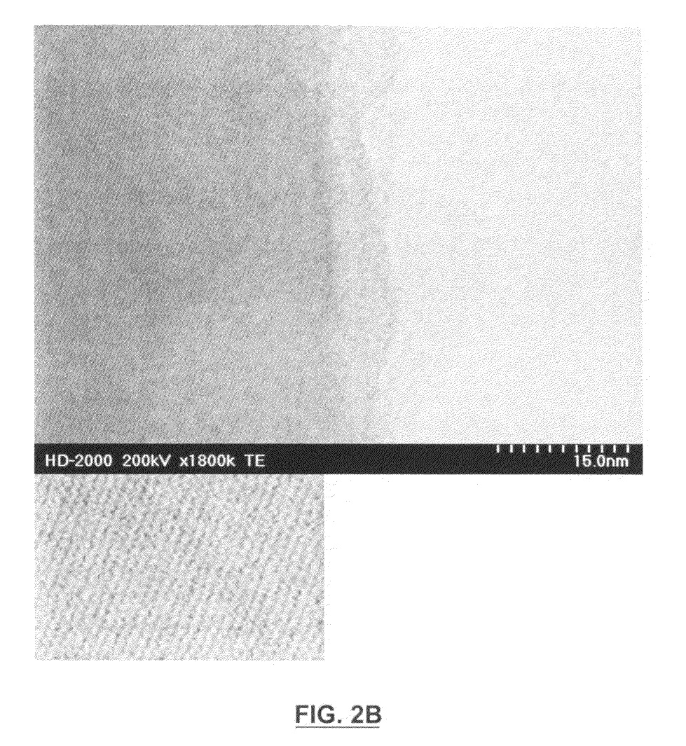

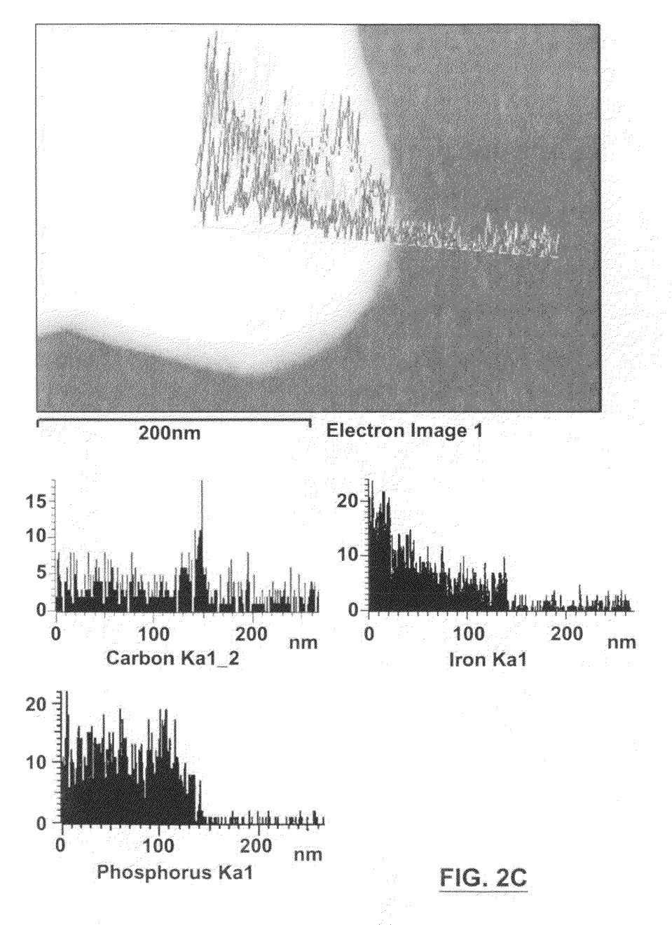

The electrochemical properties of Na₂FePO₄F, were examined by preparing it as a nanostructured polycrystalline phase by both solid state synthesis, and a novel sol-gel route that incorporates 1-3% carbon on the surface of the material. The carbon content was determined from gravimetric analysis after dissolution of the inorganic phase. Rietveld analysis of the XRD pattern confirmed the existence of a pure single phase (FIG. 1B), with lattice parameters the same as those obtained from single crystal analysis. The SEM micrographs of the sol-gel material (FIG. 2A) reveal a uniform crystallite size distribution centered at about 200 nm. The carbon coating, estimated to be about 2-4 nm thick, is visible in the TEM image (FIG. 2B) and by elemental line scan analysis (FIG. 2C). The sharp drop-off in Fe and P intensity demarcates the edge of the crystallite, just beyond which a sharp spike in carbon intensity above the background is evident. The carbon appears mostly amorphous due to the low treatment temperature.

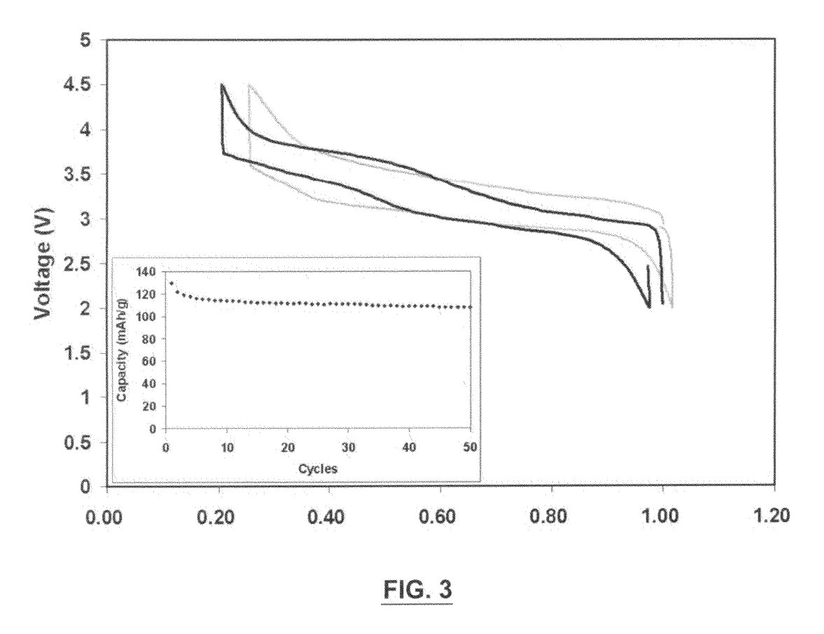

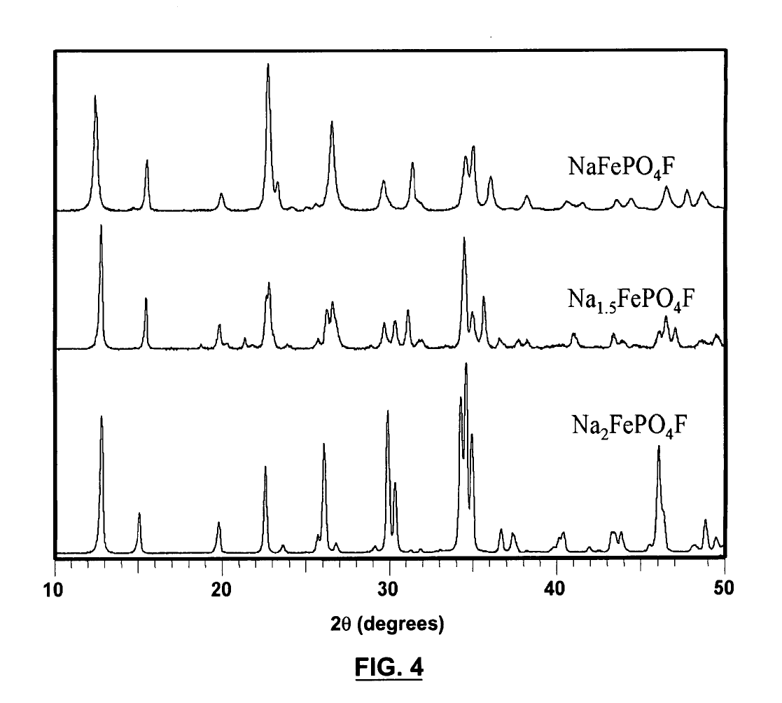

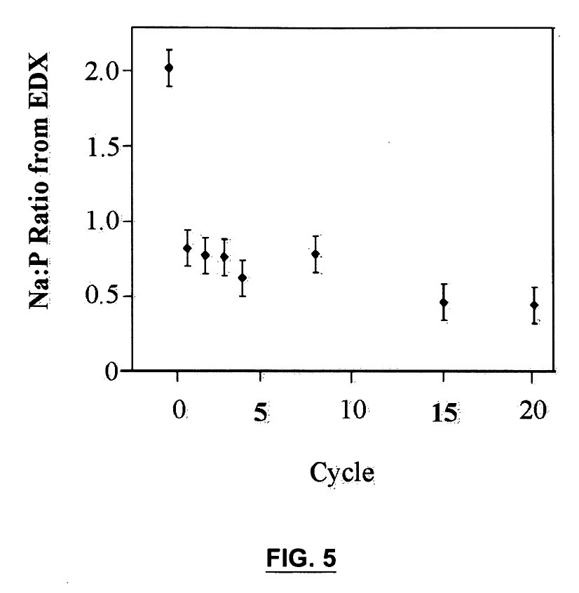

Electrodes prepared from this material were examined in coin-type cells, using lithium metal as a counter electrode. The voltage-discharge curve shown in FIG. 3 reveals a profile unlike that of the iron olivine that is characteristic of the essentially two phase reaction LiFePO₄←→ FePO₄. The sloping curve on oxidation for Na₂FePO₄F suggests the presence of a solid solution up to the composition NaFePO₄F that corresponds to the limit of sodium extraction within this voltage window. X-ray diffraction patterns demonstrate this quasi solid-solution behaviour (FIG. 4). After two cycles, the profile transforms, and both the oxidation and reduction processes suggest the presence of two quasi solid solution regimes that are present even under close-to-equilibrium conditions. Close-to-equilibrium conditions are defined as C/50, and galvanostatic intermittent titration ((GITT). These span either side of an A_{1.5}FePO₄F phase that has a limited range of solid solution behavior, given the pronounced slope in the voltage profile centered at that composition. Mixed Li/Na (de)insertion predominantly favors Li after the first anodic sweep as cycling progresses, due to the vast excess of Li⁺ in the cell. Such a process will further add complexity to the voltage profile. Ion switching was confirmed by EDX analysis of the recovered cathode material which showed that the Na/Fe (or Na/P) ratio dropped immediately from 2:1 to 1:1 after the first cycle (FIG. 5). These ratios continued to decrease, albeit more slowly, to approach a value of 0.5:1 after 15 cycles. Most significant is that ˜80% of the theoretical capacity (135 mAh/g) is attainable on the first oxidation cycle, and this reversible capacity is sustained upon cycling. Thus the presence of sodium is not a deterrent, aside from incurring a small mass deficit.

The average charge potential of 3.6V on cycling is similar to that of LiFePO₄ (3.55V). The open-circuit voltage is lower than the olivine (3.0V vs 3.45 V) and higher than that of the Fe^{3+/2+} couple in Li₃Fe(PO₄)₃ (2.8V). This is in part due to the initial presence of Na⁺ in the lattice, which is slightly lower than the redox potential. Moreover, framework connectivity determines the OCV of any given redox couple in these phosphates to a large extent.

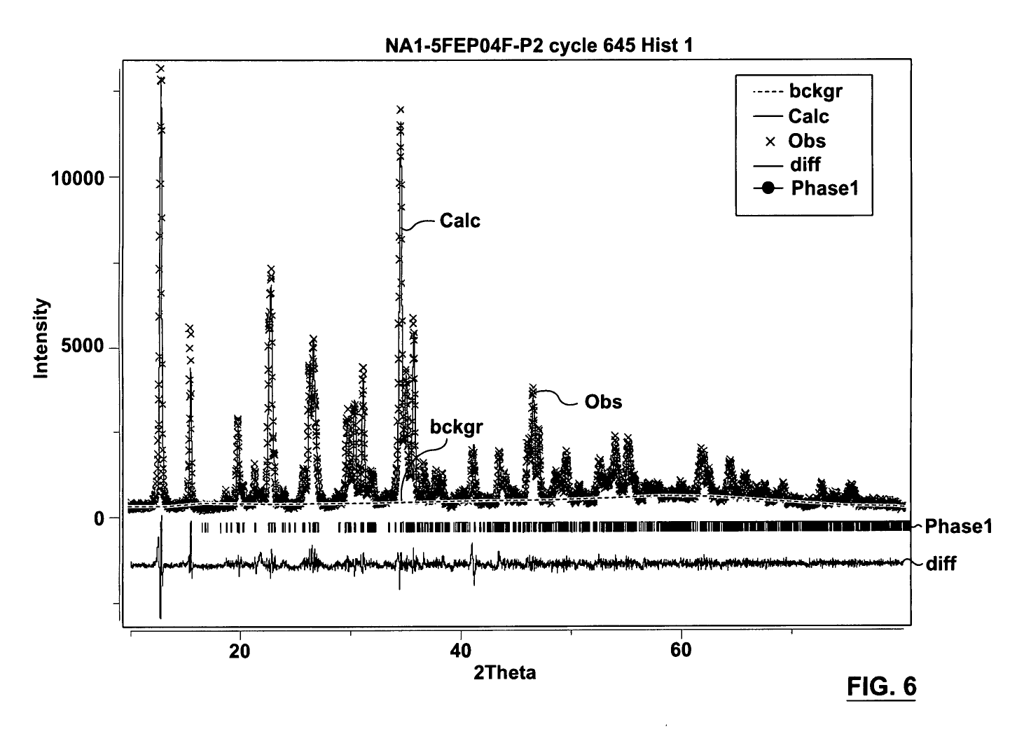

The ease of the reversible redox process suggests that the structural changes upon oxidation-reduction are minimal. Chemical oxidation of Na₂Fe^{II}PO₄F forms the single phase NaFe^{III}PO₄F. The Na:Fe ratio of 1:1 in this material was verified by SEM-EDX analysis, which showed there is little change to the crystallite morphology vis-à-vis the parent phase. Rietveld analysis was performed following an initial full-pattern match that identified that the space group of the parent phase was maintained. The fractional coordinates and thermal parameters of the atoms in the starting phase (Na₂Fe^{II}PO₄F) were refined along with the occupancy of the two sodium sites to give excellent agreement factors. The resulting structure derived from the Rietveld analysis is shown in FIG. 1B. The initial framework is maintained virtually unchanged on oxidation, with only a 3.7% volume contraction. The value is about half that sustained by the olivine LiFePO₄←→ FePO₄ couple (6.7%), and thus (de)intercalation in this framework is a lower strain process. Complete loss of Na (2) from the structure occurs upon oxidation—rather than loss of Na (1), or partial loss of both sodium cations. Furthermore, Na₂FePO₄F is also a single phase with lattice parameters intermediate between the two end members, as summarized in Table 1 (FIG. 6), for which β=91.22°. Vegard's law is not precisely obeyed, since extraction of half of the alkali results in a very slight change in symmetry to a monoclinic unit cell (Table 1). Thus, we use the term “quasi solid solution” to describe the behavior over the redox range that is spanned by Na₂₋ₓFePO₄F (x=0, 1).

TABLE 1
Lattice Parameters and Cell Volume for NaₓLi_{y}FePO₄F

| | SG | a (Å) | b (Å) | c (Å) | β (°) | Volume (Å³) |
|---|---|---|---|---|---|---|
| ^{a}Na₂FePO₄F | Pbcn | 5.2200(2) | 13.8540(6) | 11.7792(5) | 90 | 851.85 |
| ^{b}Na₂FePO₄F | Pbcn | 5.24213 | 13.87231 | 11.79610 | 90 | 857.8 |
| ^{b}NaFePO₄F | Pbcn | 5.10479 | 14.13262 | 11.36551 | 90 | 820.0 |
| ^{b}Na_{1.5}FePO₄F | P2/c | 13.92967 | 5.20098 | 11.51471 | 91.22 | 834.03 |
| ^{c}NaLiFePO₄F | Pbcn | 5.0750 | 13.6600 | 11.1350 | 90 | 771.92 |
| ^{c}Li₂FePO₄F | Pbcn | 5.0550 | 13.5610 | 11.0520 | 90 | 757.62 |

^{a}single crystal;
^{b}Rietveld refinement of powder XRD data;
^{c}values from indexing powder XRD data

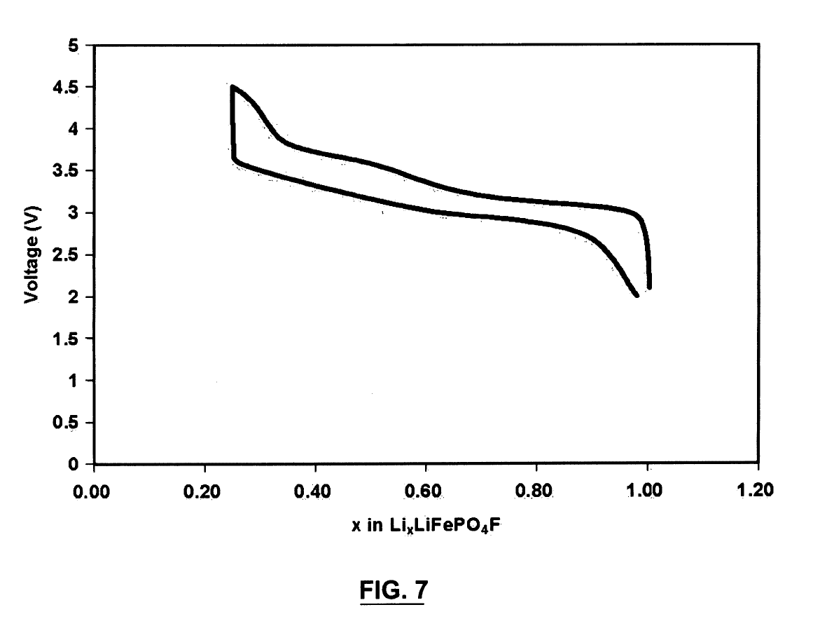

Ion exchange of the sodium cations for lithium within the lattice was accomplished by refluxing Na₂FePO₄F in a solution of LiBr. One Na was readily displaced using mild exchange conditions (50° C., 5 hr) to produce the composition LiNaFePO₄F. EDX and chemical analysis both confirmed a 1:0.97 ratio of Fe:Na. This mixed ion phase which displays lattice parameters consistent with replacement of one sodium ion was also prepared by reductive lithiation of the oxidized phase NaFePO₄F using Li. Both Na (1) and (2) were displaced upon more rigorous ion exchange treatment. The latter phase has a Na:Fe content of about 0.20:1.0, and lattice parameters consistent with the formation of a highly lithiated composition. This material is designated “Li₂FePO₄F” for brevity. Its voltage charge-discharge profile shown in FIG. 7 reveals a shape very similar to that of Na₂FePO₄F after 5 cycles, and the same reversible capacity of ˜80%. This is expected since Li preferentially replaces Na in the lattice upon electrochemical cycling as described above.

These findings for the new two-dimensional electrode material A₂FePO₄F redefine the scope for new compositions involving both sodium and lithium fluorophosphates. Although its theoretical capacity is lower than that of the olivine LiFePO₄, the achievement of 80-85% theoretical capacity without optimizing the crystal morphology/size and coating show promise for future development. Li₂FePO₄F cannot be produced from direct synthetic methods as is the case with LiFePO₄. Any attempt to synthesize Li₂FePO₄F directly yields LiFePO₄. Another alternative synthetic method is “chemie-douce”, where a metastable material is synthesized at intermediate temperature via a more stable precursor. This technique is used in synthesizing LiFeO₂, for example, where isostructural NaFeO₂ is first formed at high temperature. This material undergoes an ion exchange at slightly elevated temperature to exchange the Na for Li by refluxing it in an organic solvent. Another example of this concept used NaVPO₄F as the precursor, where an ion exchange was facilitated by refluxing the material in an organic solvent with LiBr to produce LiVPO₄F.

Sodium iron fluorophosphate has not been previously reported in the literature. Early experiments on Na₂FePO₄F suggest that it could be isostructural to the analogous Na₂FePO₄OH structure, which has been studied by analysis of single crystals produced from a hydrothermal reaction. The crystal structure of Na₂FePO₄OH is orthorhombic with space group Pbcn and lattice parameters of a=5.227(1)Å, b=13.861(5)Å, and c=11.744(3)Å. However, similar materials such as Na₂CoPO₄F have been reported in the literature and are isostructural to Na₂FePO₄OH, suggesting the iron compound may be synthesizable.

Manufacturing a cell for testing cathode materials was conducted by weighing out the active material, binder, and carbon in a weight ratio of 75:10:15. These components were mixed thoroughly in an agate mortar and pestle. Carbon was added to provide conductivity improvements and polyvinylidene fluoride (PVDF) was used as a binder to hold the components of the cathode together. The mixed powder was added to cyclopentanone, stirred and then sonicated for 30 minutes. This process was repeated three times to ensure that the cathode components were a thoroughly mixed emulsion. The mixed material was then cast onto a current collector and the organic solvent evaporated. The cast electrode was dried in a vacuum oven at 100° C. to remove residual solvent or water. Once dried, the cathode was placed in an argon glove box where the cell was assembled.

A Swagelok cell was assembled. A separator was placed in the cell to prevent contact between the two electrodes. The electrolyte was added drop wise (3 drops) onto the separator, and a lithium metal disc with a current collector was placed on top. The electrolyte was 1M LiPF₆ dissolved in a 1:1 mixture of ethylene carbonate and dimethyl carbonate (EC/DMC). The electrochemical testing was performed on MacPile II galvanostatic cycling equipment, and the rate of testing was at various rates of C. Coin cell testing was also used.

For solid state synthesis, the starting precursors, generally inorganic salts, were thoroughly mixed with a mechanical ball-mill in an organic solvent, typically running at 300 rpm for one hour to ensure that the mixture was homogeneous and to create small particle size. The mixed powder was then decomposed between 200° C. to 400° C. for two hours, and fired at higher temperatures to produce the desired phase. Powders were heated in alumina (Al₂O₃) or platinum boats, and if a component were volatile, the precursors were reacted in a sealed steel tube. If any of the components of the reaction mixture were air sensitive, the reaction was conducted in a tube furnace under a flowing argon or nitrogen atmosphere. A reducing gas such as N₂-7% H₂ was used if necessary.

Solution and gel (sol. gel) synthesis is the crystallization of products in an aqueous solution at low temperatures (i.e., 25° C.-100° C.). When reactions are performed in aqueous solutions, hydrated products typically form. However, hydration can be prevented by the dissolution of salt precursors in an organic solvent. Solutions are either boiled dry or filtered to obtain a solid product. This method is useful for generating amorphous starting material with a small homogeneous particle size. Once an amorphous phase is obtained, it can be mixed with other precursors or treated at higher temperatures, as in solid-state synthetic methods, to generate the desired product.

Most reactions were performed in a sealed silica tube while flowing an inert gas (argon or nitrogen) through the tube. Each sample was placed in an alumina (Al₂O₃) boat, placed in the tube, and set in the furnace hot zone. A boat containing carbon and covered in a zirconium mesh was placed in front of the boat, which held the reaction sample. This was a precaution used to remove any residual oxygen that may have been in the tube, outlined by the reactions below.

C(s)+O₂(g)→CO₂(g)

Zr(s)+O₂(g)→ZrO₂(g)

The inert gas was flowed through a bubbler to ensure oxygen could not backflow into the tube and was purged for 15 to 20 minutes to remove oxygen from the tube. Once assembled, the tube was placed in the furnace at a desired temperature or ramped up to the temperature desired for a particular reaction.

Ion exchange reactions utilize LiBr dissolved in an organic solvent, and heated at elevated temperature to facilitate ion exchange of Na for Li in Na₂FePO₄F. Organic solvents were used because iron (II) compounds oxidize when refluxed in water. However, the elevated temperatures also promote oxidation, so reflux reactions were performed under inert conditions as a precaution. Solvent, LiBr and sample were placed in a round bottom flask and connected to a reflux condenser. The solvent was purged for five minutes with argon to remove any dissolved oxygen by inserting a Pasteur pipette into the flask through a seal. Argon was then flowed through the flask and condenser for 15 minutes to purge the system of oxygen. A T-joint was inserted at the top of the condenser to seal the system and to allow argon to flow through the apparatus as the reaction was performed. After the system was fully purged, the argon line was switched to flow gas through the T-joint. The system was refluxed for six hours. The process was repeated until lithium was fully exchanged for sodium in the material, as determined by EDX analysis.

Lithium iron fluorophosphate (Li₂FePO₄F) can be used as a potential cathode material for lithium ion batteries, but cannot be produced by direct methods at high temperature, as it is metastable. Li₂FePO₄F may be synthesized by lithiating Na₂FePO₄F via an ion exchange reaction, as outlined below.

Na₂FePO₄F+2Li(Cl,Br)→Li₂FePO₄F+2Na(Cl,Br)

A new sodium iron fluorophosphate (Na₂FePO₄F) was synthesized via a flux reaction by reacting ferrous oxide (FeO) with sodium fluorophosphite (Na₂PO₃F) (which melts at 625° C.) and its crystal structure was characterized by single crystal X-ray diffraction. The fluorophosphate crystallizes in orthorhombic symmetry, space group Pbcn with lattice parameters a=5.2200(2) Å, b=13.8540(6) Å, c=11.7792(5) Å, volume of 851.85 Å³ and Z=8. The refinement was conducted using a total of 1839 unique reflections, with resulting agreement factors of R and wR(F²) of 0.0294 and 0.0660 respectively. This study reveals that the structure of Na₂FePO₄F is iso-structural to the hydroxyl substituted analogue Na₂FePO₄OH determined by analysis of single crystals produced in a hydrothermal reaction. As depicted in FIG. 11, the latter crystallizes in orthorhombic symmetry with space group Pbcn and similar lattice parameters of a=5.227(1) Å, b=13.861(5) Å, and c=11.744(3) Å. The sodium atoms have two distinct positions, one located adjacent to phosphate polyhedra and the other residing in channels between polyhedra.

A single-phase microcrystalline powder of Na₂FePO₄F was synthesized by a solution method, which produced homogeneous particle size distribution, and also by solid state reaction. Rietveld refinement of diffraction pattern of Na₂FePO₄F produced by the solution synthetic route, yielded lattice parameters that were similar to the single crystal data. The solution method that utilized DME as the solvent produced a material with the smallest particle size. Roughly 1 wt. % of carbon was deposited on the surface of the Na₂FePO₄F crystallites forming a carbon composite. Electrochemical performance of Na₂FePO₄F showed excellent results with a reversible capacity of 80% over successive cycling. Additional carbon was deposited on the surface of the Na FePO₄F crystallites by adding 1,3,5-benzene tricarboxylic acid to the solution synthesis. Gravimetric analysis revealed that this composite contained approximately 2.5 wt % of carbon. Raman spectroscopy verified that the carbon was much more graphitic than the material synthesized with only acetate salts as the carbon source.

The NaFePO₄F phase can be obtained by charging Na₂FePO₄F in an electrochemical cell. A powder of NaFePO₄F can also be obtained by chemically oxidizing the parent phase. The diffraction pattern of the oxidized material was indexed, and the lattice parameters obtained from this routine were refined with GSAS. The Rietveld refinement also yielded atom positions of NaFePO₄F and it was determined that Na2 was removed from the structure upon oxidation of the parent. There was a 3.9% volume difference between NaFePO₄F and the parent compound.

Reflux with LiBr in methanol would not exchange both moles of sodium in Na₂FePO₄F for lithium. The sodium was fully exchanged for lithium when using acetonitrile as the reflux solvent. Although the ion exchange method successfully exchanged both sodium, there was a problem with oxidation and this was apparent in the electrochemical results. The degree of oxidation was less when using acetonitrile in the reflux, but it was still substantial (Fe³⁺ content was ½ for methanol and ⅓ for acetonitrile refluxes respectively). Ascorbic acid was not a strong enough reducing agent to prevent oxidation during the reflux.

The present invention will be further understood by reference to the following non-limiting examples.

### EXAMPLE 1

### Na₂FePO₄F Synthesis Via Flux Reaction

Single crystals of Na₂FePO₄F were obtained via a flux reaction. The flux utilized in this experiment was sodium fluorophosphite (Na₂PO₃F). The reaction scheme used to produce single crystals of Na₂FePO₄F was achieved by dissolving ferrous oxide (FeO) into the flux, summarized as follows:

FeO+Na₂PO₃F→Na₂FePO₄F [R1]

The precursors FeO and Na₂PO₃F (99+%, Alfa Aesar) were mixed in an agate mortar. The ferrous oxide was initially ground in an agate mortar to ensure a fine powder was mixed with Na₂PO₃F. The mixed precursors were then poured into a gold crucible and placed in a silica glass tube. The reaction outlined by equation R1 was conducted in a flowing N₂-7% H₂ atmosphere and the temperature was held at 625° C. for 15 hours. A reducing gas was used to ensure that Fe remained in the 2⁺ oxidation state. The reaction was cooled slowly, 5° C. every 15 minutes until the temperature reached 600° C., then cooled 10° C. every 15 minutes until the temperature reached 550° C. The sample was then quenched to room temperature. The flux was dissolved in deionized water by sonicating the sample. The dissolved flux was decanted and crystallites were collected in a filter flask, rinsed with deionized water and analyzed by x-ray diffraction.

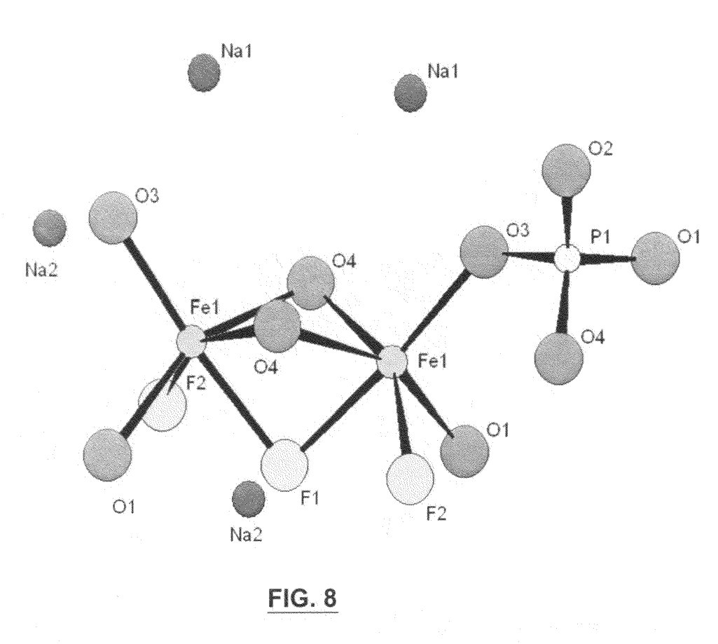

The FeO₄F₂ octahedra in Na₂FePO₄F are highly distorted because they form face sharing chains that run parallel to the [100] direction, where the F atoms are located in 5 and 6 position of the oxygen atoms in analogous FeO₆ octahedra of Na₂FePO₄OH. The F atoms are located on diads and have partial occupancy between the two F sites. Each Fe octahedron is bonded to an adjacent Fe octahedron forming a face shared dimer, as shown in FIG. 8. The dimers form chains of iron octahedra that are bridged together by adjacent Fe octahedral dimers via corner sharing. The iron chains are bridged through corner sharing with phosphate tetrahedra to form a three dimensional framework. The Fe—Fe distances in this structure are short (2.9760(4)Å) which could facilitate electron hopping between the two metal centers. In LiFePO₄, which is a known insulator, the Fe—Fe bond length is approximately 3.87 Å for octahedra that are corner shared.

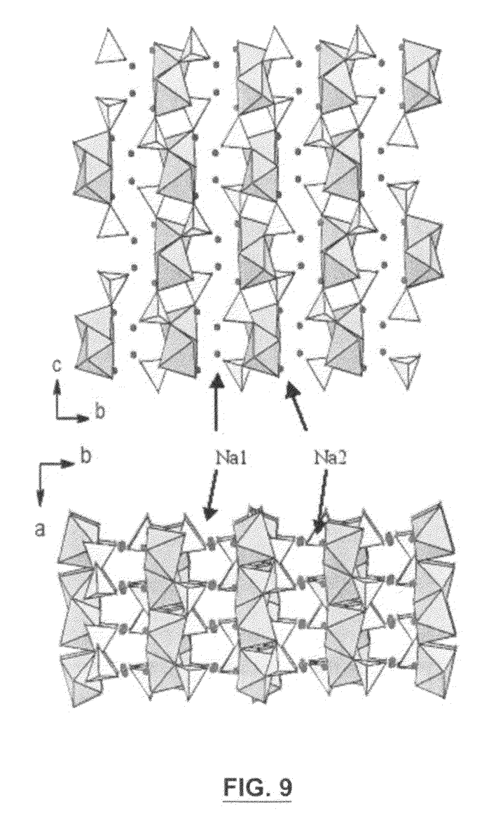

The sodium cations are located in interstitial voids of the pseudo two-dimensional structure of Na₂FePO₄F. There are two independent sodium positions in this structure. The polyhedra network is shown in FIG. 9. It is apparent that Na₁ resides in channels that run along the [100] direction and by inspection, it seems that this channel should have promising transport properties because Fe and PO₄ polyhedra do not seem to impede these pathways. However, it is not clear if Na₂ channels have promising transport pathways because sodium ions would have to hop over adjacent polyhedra. If this material were to be utilized as a cathode material for a battery, it would be highly unlikely that both cations could be removed from the structure because iron would have to be oxidized to the 4⁺ oxidation state. As stated in the introduction, because Fe³⁺ has a high spin d⁵ configuration (it would require a large amount of energy to remove an electron from iron to undergo a transition from Fe³⁺ to Fe⁴⁺), this is unlikely to occur. It is believed that Na1 would be the most electrochemically active cation in this structure given its location, but this is discussed in the following sections.

### EXAMPLE 2

### Microcrystalline Na₂FePO₄F Synthesis Via Solid State Synthesis

The Na₂FePO₄F produced via solid-state synthesis was obtained by the following reaction schemes outlined below:

FeC₂O₄.2H₂O+NH₄H₂PO₄+½Na₂CO₃+3/2NaF→Na₂FePO₄F+3H₂O+½H₂+NH₃+5/2CO₂+½NaF [R2]

FeC₂O₄.2H₂O+NH₄H₂PO₄+NaHCO₃+1.5NaF→Na₂FePO₄F+3H₂O+H₂+NH₃+5/2CO₂+½NaF

FeC₂O₄.2H₂O+NaNH₄HPO₄+1.5NaF→Na₂FePO₄F+2H₂O+H₂+NH₃+2CO₂+½NaF [R3]

FeC₂O₄.2H₂O+NaH₂PO₄.H₂O+1.5NaF→Na₂FePO₄F+3H₂O+H₂+2CO₂+½NaF

Chemicals used in each synthesis had the following purity: FeC₂O₄.2H₂O (Aldrich, 99+%), NH₄H₂PO₄ (BDH, 99+%), NaF (Aldrich 99+%), Na₂CO₃ (BDH, 99+%), NaHCO₃ (BDH, 99+%), NaNH₄HPO₄ (Fisher, 99+%), and NaH₂PO₄.H₂O (Alfa Aesar. 98%). Each sample was prepared by adding the precursors in the stoichiometric amounts outlined above to produce between 1.5 and 2 grams of desired product. The precursor mixture was ball-milled for one hour in acetone at 300 rpm and air dried in a fume hood to remove residual acetone. The mixture was then fired at 300° C. for two to three hours in an inert atmosphere (N₂ or Ar) to decompose the precursors and remove the volatile components of the salts. The decomposed sample was ball-milled by the same procedure to ensure the precursors were mixed homogeneously. The sample was then heat treated at 550° C. in N₂ or Ar for six hours to produce the desired phase. The material was washed after heat treatment to remove residual NaF and the product was collected with a filter funnel using Wattman No. 4 filter paper. Samples were rinsed with water, followed by a wash with ethanol and then acetone, to ensure all the water was removed. The materials were characterized with powder X-ray diffraction.

Excess amounts of NaF were vital because using stoichiometric amounts did not produce a pure phase. The use of one mole of NaF would produce Na₂FePO₄F with small amounts of NaFePO₄ because NaF is volatile under the reaction conditions. Fluorides readily react with silica, and a milky residue was deposited on the silica tube where the reaction was performed.

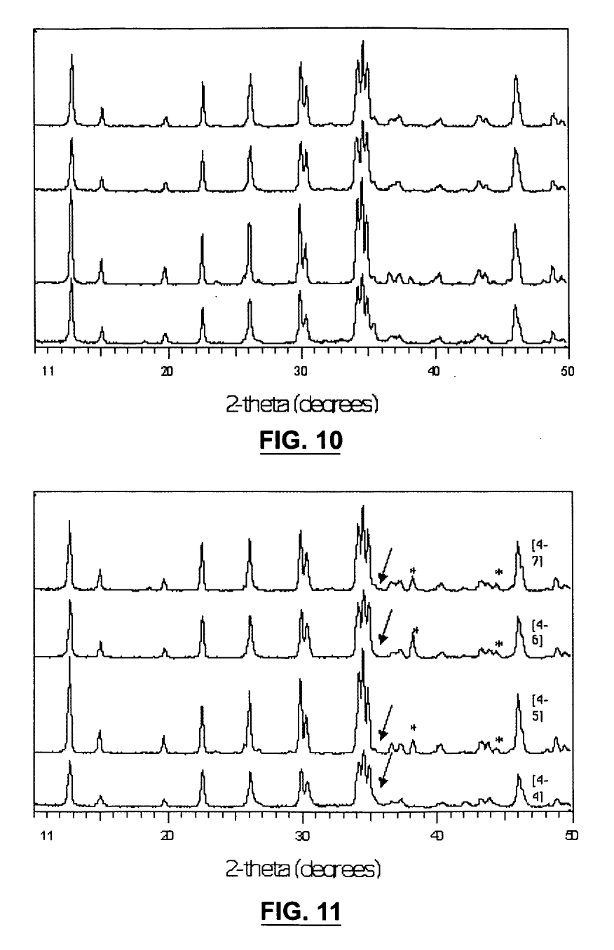

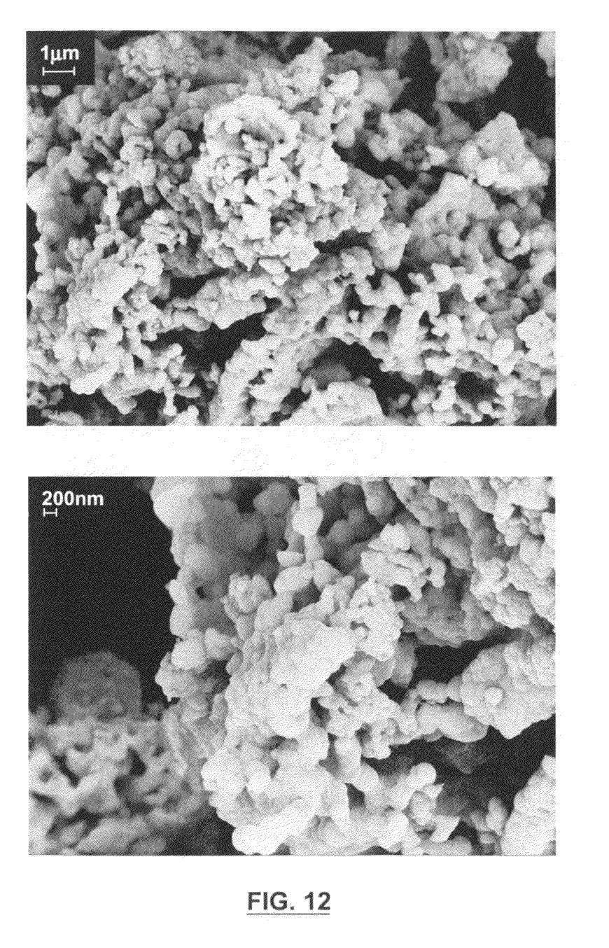

Each of the reaction schemes produced the desired Na₂FePO₄F phase, however, each also resulted in a variable amount of maghemite (a magnetic form of Fe₂O₃) as a by-product. Reaction R2 generated the largest amount of Fe₂O₃, while reaction R3 generated small amounts of the impurity. This can be seen by examining the X-ray diffraction patterns in FIG. 10. It was also determined that heating the precursors for shorter amounts of time, such as six hours, produced smaller amounts of Fe₂O₃ than compared to heating for 16 hours, which is also shown on the previous page in FIG. 11. Out of all the reactions utilized for synthesizing Na₂FePO₄F by the solid-state route, none of them produced a pure phase. Material produced via reaction R3 produced the best results, but a pure phase could not be synthesized every time the reaction was performed. The particle size distribution of the material produce via the solid state synthetic method was broad, ranging from sub-micron particles to 5 micron blocks, as shown by the SEM micrographs in FIG. 12. To achieve better crystallite size homogeneity, solution synthesis was attempted.

### EXAMPLE 3

### Microcrystalline Na₂FePO₄F Synthesis Via Solution Synthesis

This route was based on dissolving precursors into an organic solvent such as ethylene glycol (EG), dimethoxyethane (DME) or ethylene glycol dimethyl ether (EG-DME). The solution was stirred vigorously and the solvent evaporated in either a fumehood or under a heat lamp. The powder produced in DME could not be dried in an oven because iron (II) acetate oxidized to a red product. Therefore, the material produced in DME was stirred until most of the solvent evaporated, and then was dried under a heat lamp for 15 to 20 minutes.

Fe(CH₃COO)₂+H₃PO₄+NaCH₃COO+1.5NaF→Na₂FePO₄F+½H₂+CH₄+3CO₂+½NaF

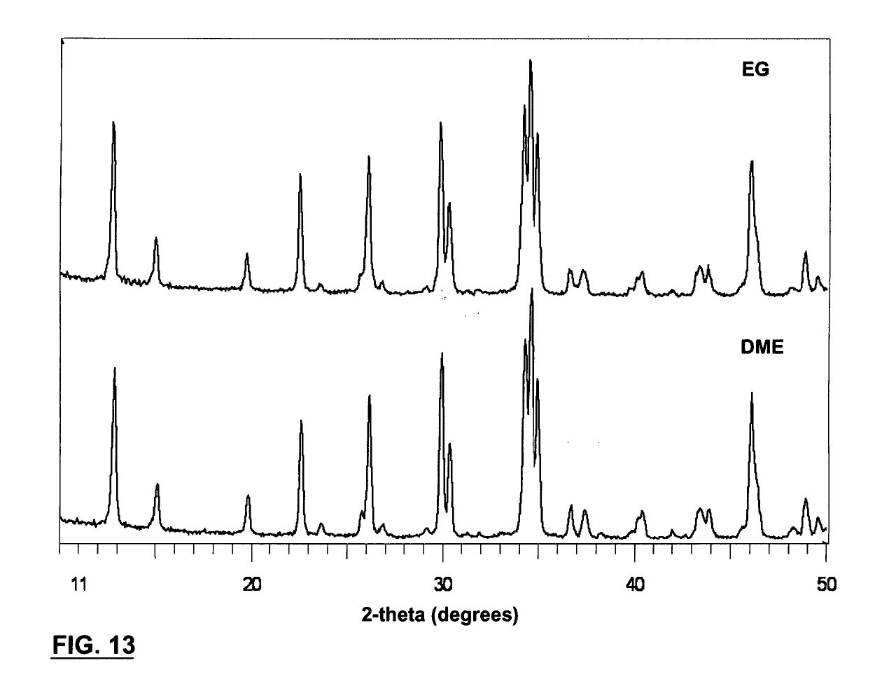

This was a solution synthesis that was modified from one used to produce carbon coated LiFePO₄. Chemicals used in each synthesis had the following purity: Fe(CH₃COO)₂ (Alfa Aesar, 99+%), NaCH₃COO (BDH, 99+%), H₃PO₄ (Aldrich, 98%), and NaF (Aldrich, 99+%). Once the solvent was removed from the reaction mixture, the powder was ball-milled for one hour in acetone at 300 rpm. The sample was then heated for 2 hours in nitrogen at 300° C. to decompose the organic components of the precursor. The decomposed powder was then ball-milled again under the same conditions and then fired for six hours in nitrogen at 550° C. to produce Na₂FePO₄F. This reaction produced a pure phase of the desired product for both solvents and this is shown in the diffraction pattern in FIG. 13. The reaction in EG-DME was more efficient because the solvent could be evaporated in a matter of hours. In contrast, it took one or two days to evaporate EG from the sample, as it must be heated gently with a heat lamp to ensure that iron does not oxidize in the process.

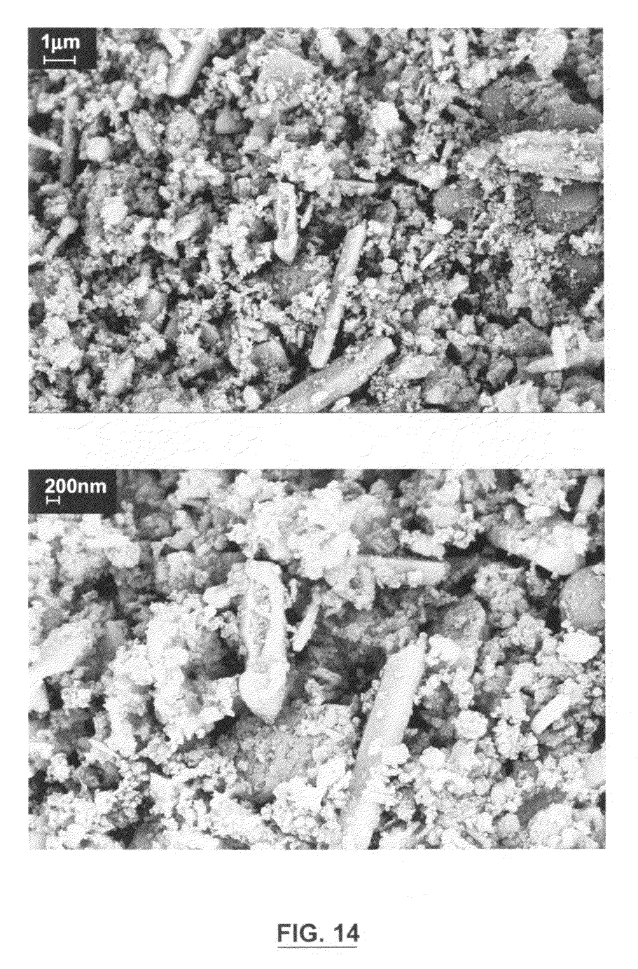

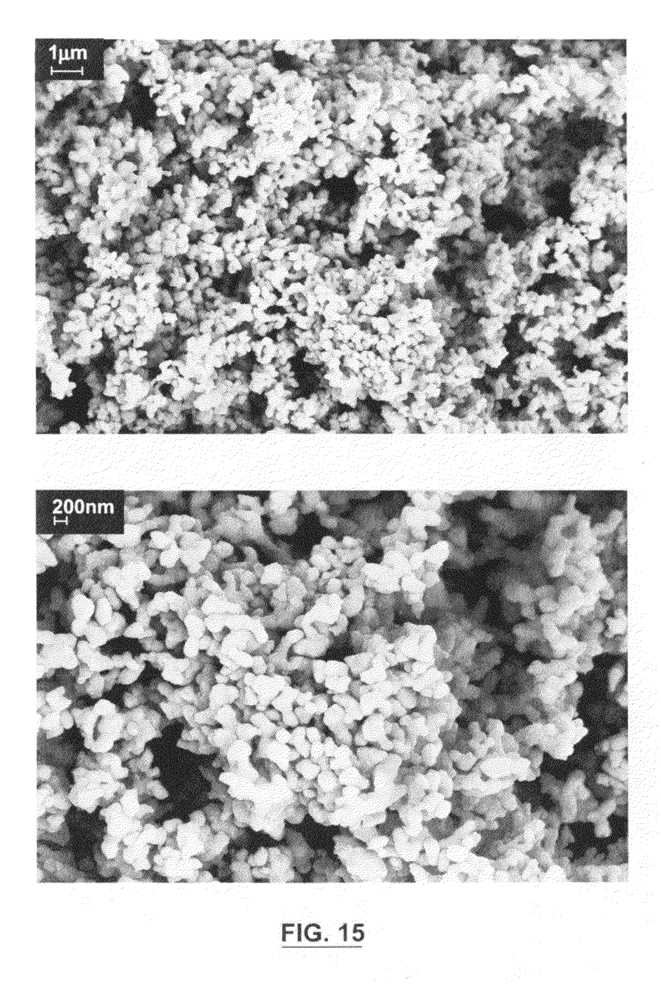

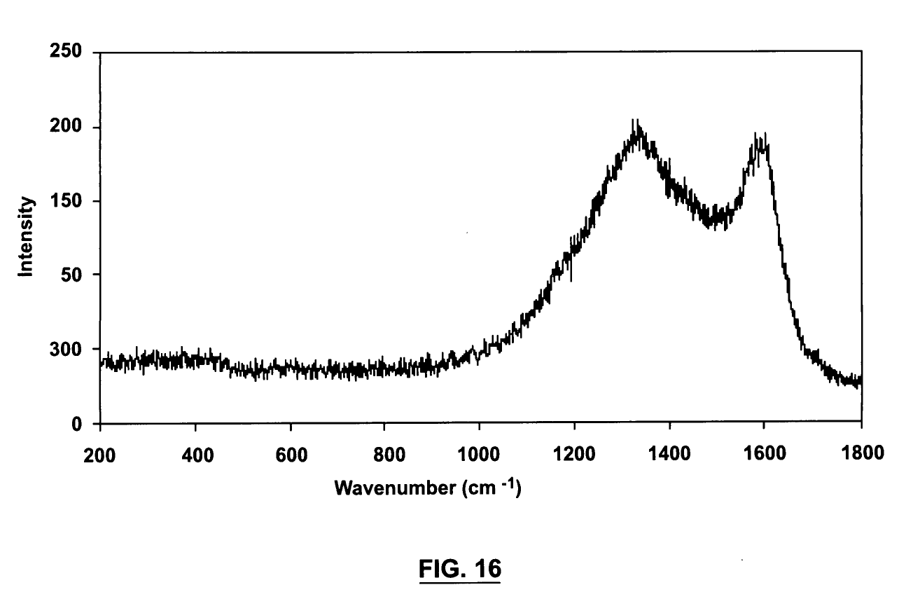

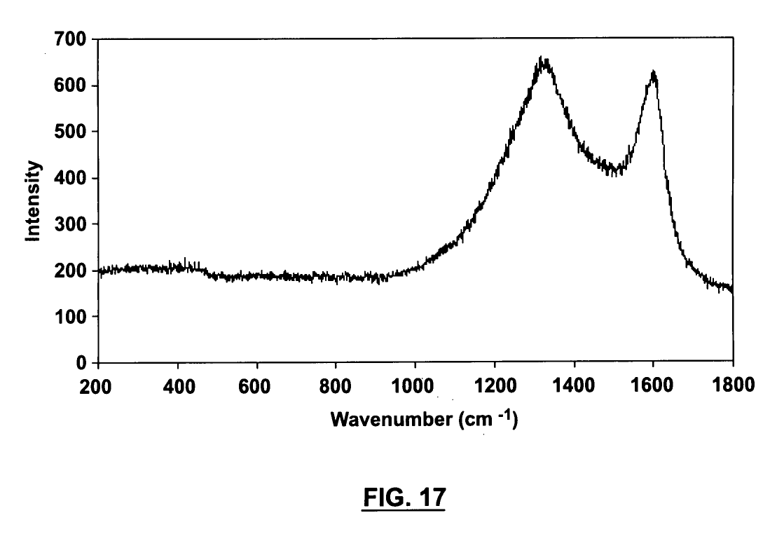

This solution method not only produced single-phase Na₂FePO₄F, but SEM micrographs (FIG. 14) showed that smaller particles of Na₂FePO₄F were produced than in the solid-state method. Furthermore, the sample produced in EG-DME had a homogenous particle size that was much smaller than the method which used EG as the solvent, as shown in FIG. 15. The material produced in EG had crystallites ranging from 5 micron long blocks to sub-micron particles. The small particle size of the material produced by the EG-DME method is ideal for optimal electrochemical performance due to short path-lengths that lithium ions would have to migrate during the intercalation process.

The method used to prepare Na₂FePO₄F produced a pure single phase as shown by its diffraction pattern. Rietvelt refinement confirmed that no impurities were produced in the solution synthesis. The charge-discharge profile of a cell prepared using Na₂FePO₄F as a cathode and lithium metal as the counter electrode suggests 80% reversible capacity. The cathode composite was prepared from active material, super S carbon, and PVDF binder in a 75/15/10 ratio. The electrode mix was 0.01293 g and the active material itself had 1% carbon by weight, which was deposited during the decomposition of the precursors. The amount of carbon was determined by gravimetric analysis (i.e. by dissolving the active material in concentrated hydrochloric acid). Carbon remained suspended in the solution and was collected with a filter flask and weight percent of carbon was calculated from the carbon retrieved. Ideally, TGA would be used to determine the weight percent of carbon; however, this technique cannot be used because constant mass is not reached when the active material composite is burned in oxygen. The current density was 0.1368 mA/cm², equal to a rate of C/10. The cells cycled in a voltage range of 2-4.5V showed low polarization. A phase transition is evident at 0.5 mole of Na as seen from the inflection point in the charge and discharge curves.

It has been documented in numerous studies that sol-gel synthetic methods employing various carbonaceous salt precursors will deposit residual carbon to form composites. Gravimetric analysis indeed showed, that the sol-gel synthesis outlined by equation R4 deposits roughly 1% of carbon by weight. Raman spectroscopy of Na₂FePO₄F produced via sol-gel synthesis shows that carbon is present and that there is more disordered (sp³) carbon than graphitic. The synthesis was modified by adding 1,3,5-benzene tricarboxylic acid to increase the graphitic content. Raman spectroscopy of the composite produced using 1,3,5-benzene tricarboxylic acid shows that the G band had a higher intensity than in the spectrum that contained only the carbon deposited from the solution method. Gravimetric analysis of the material with addition of 1,3,5-benzene tricarboxylic acid showed that it had approximately 2.5 wt. % carbon.

Chemical oxidization of Na₂FePO₄F was achieved by using stoichiometric amounts of NOBF₄ as outlined by the following reaction.

Na₂FePO₄F+NOBF₄→NaFePO₄F+NaBF₄+NO↑ [R4]

This reaction was conducted by stirring the material in acetonitrile for 12-15 hours to ensure that the reaction proceeded to completion. The powder was collected by filtration. The diffraction pattern of NaFePO₄F differs from Na₂FePO₄F, but close examination of the reflections suggests that the orthorhombic space group is maintained.

A diffraction pattern of NaFePO₄F revealed a pure phase with no impurities. Rietveld refinement produced agreement factors that are considered to be quite satisfactory for a pure phase. The diffraction pattern was refined with the space group Pbcn to yield lattice parameters of a=5.10187(2)Å, b=14.1224(6)Å, and c=11.36096(7)Å, and a volume V=818.5688(3)Å³. This yields a difference in volume of 3.9% between NaFePO₄F and the parent phase. It was also determined, from the refinement, that upon chemical oxidation, Na₂ is removed from Na₂FePO₄F to produce NaFePO₄F. This was determined by refining the occupancy of each sodium and it was discovered that the fractional occupancy of Na₂ refined to zero.

A solid solution is a compositional variation that is the result of substitution of an ion or ionic group for another. Such a compound is considered a solid solution when the crystal structure remains in a single homogeneous phase even when the composition of a phase varies. An example of a solid solution in nature is that of the mineral class olivine, where the minerals fayalite and forsterite make up the iron and magnesium end members of (Fe,Mg,)₂SiO₄.

The NaₓFePO₄F system (where x=1, 1.25, 1.5, 1.75, and 2) was analyzed to determine if this series exhibited solid solution behaviour at room temperature. Sodium was removed from Na₂FePO₄F by oxidation with stoichiometric amounts of NOBF₄, according to the following reaction:

Na₂₋ₓFePO₄F+xNOBF₄→Na₂₋₂ₓFePO₄F+xNaBF₄+xNO↑

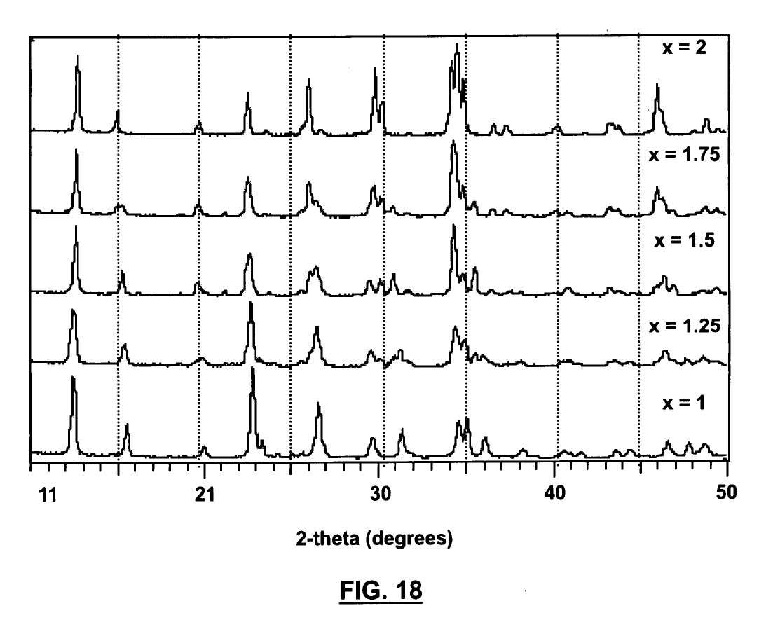

The diffraction patterns of the range of the compositions are illustrated in FIG. 18. It can be concluded from the series of diffraction patterns that the system of NaₓFePO₄F (where x=1, 1.25, 1.5, 1.75, and 2) exhibits solid-solution behaviour at room temperature. Only one phase appears to be visible in these diffraction patterns, where features from the parent compound are preserved as sodium is removed from Na₂FePO₄F.

The pristine material was used to generate Li₂FePO₄F, which can potentially be used as a new cathode material for lithium ion batteries. The theoretical capacity of Li₂FePO₄F is 146 and 292 mAh/g for one and two moles of lithium, respectively. However, the second mole of lithium cannot be extracted from Li₂FePO₄F because this electrochemical process utilizes the Fe^{3+/4+} redox couple, which is a transition with a high-energy barrier. The Fe³⁺ is in the d⁵ state, which has the d orbitals half filled and is thus very stable, such that oxidation to Fe⁴⁺ requires a voltage in the range where the electrolyte would decompose.

### EXAMPLE 4

### Ion Exchange in Methanol

Ion exchange in an organic solvent was conducted by refluxing 0.5 g of Na₂FePO₄F in a 5M solution of LiBr in methanol at 65° C. The suspension was refluxed for eight hours in air with vigorous stirring. X-ray diffraction showed a shift in the lattice parameters after reflux, suggesting that ion-exchange occurred. EDX analysis revealed a Na:Fe:P atomic ratio of 1:1:1, confirming that roughly one mole of Na was removed during the process. The proposed reaction is:

Na₂FePO₄F+LiBr→LiNaFePO₄F+NaBr

However, the Li content cannot be analyzed by EDX owing to its low atomic weight, and subsequent electrochemical experiments suggests partial Fe oxidation occurs during ion-exchange, with concomitant loss of Li. The reflux was repeated in an argon atmosphere, and the LiBr concentration was reduced to 1M. As an additional precaution, 2 moles of LiI were added to the solution to prevent oxidation of the iron, i.e.:

NaFePO₄F+LiI→(Li,Na)FePO₄F+½I₂

where the redox reaction is:

Fe³⁺+I⁻→Fe²⁺+½I₂

The lower LiBr concentration meant that two successive overnight reflux reactions were required for the exchange of 1 mole of Na, since starting material was evident in the XRD pattern after the 1^{st} step.

The charge-discharge profile of a cell prepared using this (Li,Na)FePO₄F material as a cathode and lithium metal as the counter electrode shows a current density of 0.0947 mA/cm², equal to a rate of C/1. The composite electrode weight was 0.00902 g and the active material itself had roughly 1% carbon by weight. The cells cycled in a voltage range of 2.5V showed low polarization and a very promising reversible capacity of 90%. However, 0.3 mol excess Li was inserted into the structure upon discharging the cell, indicating that again, some oxidation of Fe²⁺ to Fe³⁺ occurred despite the presence of the LiI. This is in accord with the lack of colour change of the solution from clear to brown (indicative of I₃⁻).

### EXAMPLE 5

### Ion Exchange in Acetonitrile

Acetonitrile was explored as an ion-exchange medium due to the difficulty in removing water from methanol, which might be the source of the oxidation problem. Acetonitrile also has a higher boiling point of 81.6° C., which would facilitate the kinetics of ion-exchange. As a precaution, the acetonitrile was stored in a bottle over dried molecular sieves to ensure the solvent remained anhydrous. The reflux reaction was carried out under flowing argon, using a suspension of 0.5 g of Na₂FePO₄F in a 1M solution of LiBr for six hours. This process was repeated once to ensure that the ion exchange was complete. The material from the 2nd reflux was analyzed with EDX, revealing a Na:Fe:P ratio of close to 0.1:1.0:0.9. The diffraction patterns corresponding to the 1^{st} and 2^{nd} reflux steps also show a progressive shift in lattice parameters indicative of Li/Na exchange.

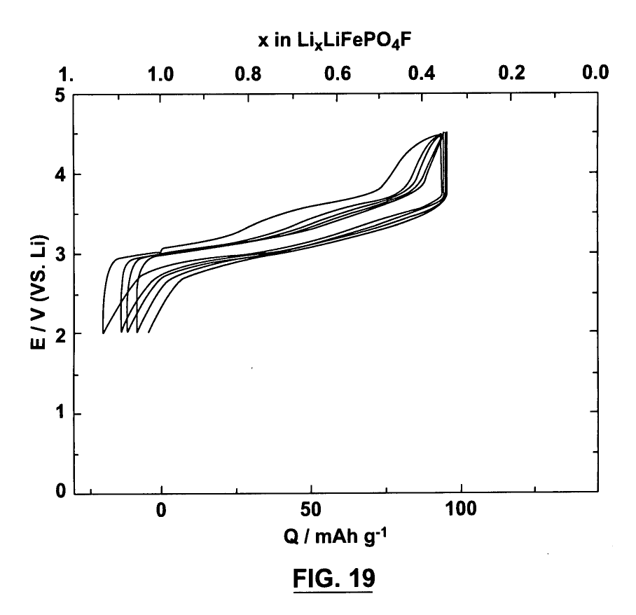

The charge-discharge profile of a cell was prepared using this material as a cathode and lithium metal as the counter electrode. The results in FIG. 19 were collected on a cathode weighing 0.01974 g, about twice the loading as for LiNaFePO₄F described above. The current density was 0.2263 mA/cm², equal to a rate of C/10. The cells cycled in a voltage range of 2-4.5V showed low polarization and good reversibility. The lower reversible capacity (60%, compared to 90% above) could be due to the much higher cathode loading in this cell. The inflection point in the electrochemical curve at 0.5 mole of Li is comparable to that seen for Na₂FePO₄F, suggestive of a phase transition. Note that the oxidation problem was less in this material, as only 0.1 mol of Li was reinserted into the structure upon discharging the cell. The ratio of “additional oxidative capacity” to total reversible capacity (0.1/0.6) is thus less than for the methanol medium product (0.3/0.9). Dry acetonitrile as a solvent reduced the amount of oxidation compared to (Li,Na)FePO₄F produced in methanol.

The next attempts to prevent the iron from oxidizing during the reflux centered on the addition of ascorbic acid to the reflux solution, to act as an internal reducing agent. A molar equivalent to Na₂FePO₄F (1.2 g) in 1M LiBr/acetonitrile, a one mole equivalent of ascorbic acid was added, and the suspension was refluxed under Ar for 12 h. The material was recovered by filtration. EDX showed that residual sodium remained in the material, by the Na:Fe:P ratio of 0.36:1.0:0.9. A second reflux of six hours decreased the Na content to yield a Na:Fe:P ratio of 0.17:1.0:1.1.

This product was chemically reduced with LiI by reacting 0.4 g of the exchanged product with an excess amount of LiI in acetonitrile for 12 hours in a glove box. The LiI solution had turned deep brown, indicating that reduction had occurred. Diffraction patterns from the materials produced by refluxing with ascorbic acid and chemical reduction with LiI clearly shows the progressive shift in lattice parameters suggestive of Li/Na exchange. The d-spacings of reflections that correspond to alkali atoms which dominates the structure factor (denoted by *) in the diffraction pattern have decreased in magnitude. This result is expected when inserting smaller atoms into the structure because the volume of the unit cell would decrease, which corresponds to smaller d-spacing in the diffraction pattern.

It will be appreciated by those skilled in the art that other variations of the preferred embodiments may also be practiced without departing from the scope of the invention.

What is claimed is:

1. A compound having the general formula (LiₐNa₂₋ₐ)FePO₄F wherein 0<a≦2.

2. The compound of claim 1 wherein 1.4≦a≦2.

3. The compound of claim 1 further comprising a conductive coating.

4. The compound of claim 3, wherein the coating is a carbon composite.

5. A process for synthesizing (Li,Na)₂FePO₄F from Na₂FePO₄F by ion exchange, comprising refluxing a suspension of Na₂FePO₄F in a solution of LiBr in an organic solvent under an inert atmosphere for a refluxing period.

6. The process of claim 5, further comprising the additional step of refluxing a second time a suspension of Na₂FePO₄F in a solution of LiBr in an organic solvent under an inert atmosphere for a second refluxing period.

7. The process of claim 5 wherein the organic solvent is anhydrous acetonitrile.

8. The process of claim 5, wherein the solution of LiBr is between 0.5 and 1.5 M.

9. The process of claim 5, wherein the first and second refluxing periods are at least 6 hours.

10. The process of claim 5, further comprising addition to the reflux solution of one molar equivalent of ascorbic acid.

11. A process for synthesizing (Li,Na)FePO₄F by exchanging lithium ions for sodium ions in Na₂FePO₄F, the process comprising the following steps:
i) removing one mole of Na from Na₂FePO₄F by oxidation; and
ii) treating NaFePO₄F with a solution of LiI in an organic solvent under an inert atmosphere.

12. The process of claim 11 wherein the oxidation is chemical oxidation.

13. The process of claim 11 wherein the oxidation is electrochemical oxidation.

14. The process of claim 12 wherein the chemical oxidation is effected by a chemical oxidant selected from the group of chemical oxidants comprising NOBF₄, NO₂BF₄, and K₂S₂O₈.

15. The process of claim 14 wherein the chemical oxidant is NOBF₄.

16. Use of the compound of claim 1 as a cathode material for a lithium ion battery.

17. Use of the compound of claim 4 as a cathode material for a lithium ion battery.

18. A process for solution synthesis of Na₂FePO₄F, the process comprising the following steps:
i) preparing a precursor solution by dissolving Fe(CH₃COO)₂, H₃PO₄ NaCH₃COO, and NaF in an organic solvent;
ii) removing the solvent;
iii) ball-milling the resultant powder from step ii) in an inert solvent at a selected speed;
iv) heating the mixture from step iii) at a first temperature for a selected period in an inert atmosphere;
v) ball-milling the mixture from step iv); and
vi) heat treating the mixture from step v) at a second temperature in the inert atmosphere for a second period.

19. The process of claim 18, wherein the first temperature is at least 300° C.

20. The process of claim 18, wherein the first period is between 30 and 90 minutes.

21. The process of claim 18, wherein the second temperature is between 550° C. and 650° C.

22. The process of claim 18, wherein the second period is between 90 and 150 minutes.

23. The process of claim 18, further comprising the additional step of adding 1,3,5-benzene tricarboxylic acid in step i.

24. A process for solution synthesis of Na₂FePO₄F in aqueous solution, the process comprising the following steps:
i) preparing a precursor solution by mixing (NH₄)₂Fe(SO₄)₂, H₃PO₄, NaOH, and NaF in water;
ii) heating the mixture in an autoclave under autogeneous pressure at a temperature between 180° C. and 220° C. for between 12 and 24 hours.

25. The process of claim 24, wherein the temperature is 200° C., and the time is 18 hours.

26. A cathode material for a lithium ion battery comprising Na₂FePO₄F, carbon and a binder.

27. The cathode material of claim 26, wherein the weight percentage of Na₂FePO₄F is between 50% and 99%.

28. Use of the cathode material of claim 26 in a lithium ion battery.

29. A process for the solid state synthesis of Na₂FePO₄F, the process comprising the following steps:
i) ball-milling a stoichiometric amount of NH₄H₂PO₄, Fe(C₂O₄).2H₂O, NaHCO₃;
ii) heating the mixture to a first temperature of 350° C. under an inert atmosphere;
iii) adding a stoichiometric amount of NaF and ball-milling the mixture;
iv) heating the resultant mixture from step iii) at a selected temperature in an inert atmosphere for a selected time period.

30. The process of claim 29, wherein the selected temperature is between 550° C. and 650° C. and the selected time period is between 2 and 8 hours.

31. The process of claim 30 wherein the selected temperature is 550° C. and the selected time period is 6 hours.
